(19) United States
(12) Patent Application Publication
(10) Pub. No.: US 2001/0010767 A1
(43) Pub. Date: Aug. 2, 2001

(54) Electrophotographic imaging device

(75) Inventor: Takaaki Watanabe, Tokyo (JP)

Correspondence Address: Paul-J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/774,896

(22) Filed: Jan. 31, 2001

(30) Foreign Application Priority Data
Jan. 31, 2000 (JP) 2000-22204

(51) Int. Cl. G03G 21/20

(52) U.S. Cl. 399/92; 399/93

(57) ABSTRACT

An electrostatic imaging device such as copying machine includes a photoreceptor, a corona electrifier for the photoreceptor, a developer and a ventilation system. The ventilation system includes a suction duct having a suction port for absorbing ozone generated by the corona electrifier, an exhaust duct having a pair of air nozzle for blasting air to the developer for prevention of ink leakage, an ozone remover for removing ozone from the air inside the duct to provide clean air to the air nozzle.

### BACKGROUND OF THE INVENTION

1. Field of the Invention

The present invention relates to an electrophotographic imaging device and, more particularly, to an electrophotographic imaging device such as a printer or a copying machine using an electrophotographic technique.

2. Description of the Related Art

In an electrophotographic imaging device such as a printer or a copying machine, a corona discharge is generated within the device for electrification of photoreceptor. The corona discharge generates undesirable ozone, which deteriorates the photoreceptor and thus should be recovered for decomposition.

FIG. 1 shows a conventional copying machine described in a Patent Publication JP-A-9-152817. The copying machine includes a photoreceptor drum 41 having a cylindrical shape, a sheet carriage 42 for receiving a sheet from the photoreceptor drum 41 to carry the same, a transcription/separation charger 43 for generating a corona discharge on the photoreceptor drum 41 for electrification thereof, and an exhaust fun 62 for exhausting air from the transcription/separation charger 43 through an air duct 44 for ventilation.

FIG. 2 shows the detail of the air duct and the fan in the copying machine of FIG. 1. The fan 62 exhausts the air from the internal of the sheet carriage 42 as well as the transcription/separation charger 43 via branch ducts 44a and 44b, respectively. A valve 61 and a filter 63 are disposed inside the branch ducts 44b and 44c.

The sheet carriage 42 transfers the sheet 65 while absorbing the sheet toward the sheet carriage 42 by the vacuum pressure obtained therein by the fan 62, with the valve 61 being opened. The transcription/separation charger 43 has a discharge wire 64, which is applied with a high voltage to generate a corona discharge. The transcription/separation charger 43 also generates undesirable ozone. The ozone is removed from the charger 43 by means of the fan 62, with the valve 61 being closed. The conventional copying machine of FIG. 1 is an example having an exhaust system therein.

In general, a conventional copying machine such as described above has a problem in that leakage of toner or ink occurs in the development roller in the transverse direction thereof.

The ink leakage can be suppressed by a seal provided for the development roller, or otherwise can be suppressed by an air blasting toward the development roller thereby avoiding frictional resistance between the development roller and the sheet. In the latter technique, the air to be blasted toward the development roller is introduced from outside the copying machine. This copying machine is an example having an air intake system.

It is desired that a copying machine have an air exhaust system for removing ozone as well as an air intake system for suppressing ink leakage. However, the copying machine having both the air exhaust system and the air intake system has larger dimensions and thus is expensive.

It may be considered that the exhaust system for the transcription/separation charger supplies the exhaust air to the developing roller for suppression of ink leakage. However, the air to be blasted to the developing roller should be fresh air which does not contain ozone for preventing deterioration of the photoreceptor. In addition, the air exhaust system and the air intake system have different flow rates and different pressure specifications.

### SUMMARY OF THE INVENTION

In view of the above, it is an object of the present invention to provide an electrophotographic imaging device having a single ventilation system which is capable of suppressing the toner or ink leakage from the development roller and removing ozone from the corona electrifier.

The present invention provides an electrophotographic imaging device including: a photoreceptor for generating thereon an electrostatic image on the photoreceptor: a corona electrifier for generating corona discharge to electrify the photoreceptor; a developer for developing the electrostatic latent image; and a ventilation system including a suction duct having a suction port disposed in a vicinity of the corona electrifier and an exhausting duct having an air nozzle disposed in a vicinity of the developing roller for blasting air to the coronal electrifier, a fan disposed between the suction duct and the exhaust duct for ventilating the suction duct and the exhaust duct, and an ozone remover disposed in operative relationship with the suction duct or the exhaust duct for removing ozone from air in the suction duct or the exhaust duct.

In accordance with the electrophotographic imaging device of the present invention, the single ventilation system can exhaust the ozone generated by the corona electrifier during corona discharge and blast air toward the developing roller for suppression of ink or toner leakage without deteriorating the photoreceptor by ozone.

The above and other objects, features and advantages of the present invention will be more apparent from the following description, referring to the accompanying drawings.

### BRIEF DESCRIPTION OF THE DRAWINGS

FIG. 1 is a schematic side view of a conventional copying machine.

FIG. 2 is a detailed sectional view of a part of the copying machine of FIG. 1.

FIG. 3 is a sectional view of a principal part of a electrostatic imaging device according to an embodiment of the present invention.

FIG. 4 is a perspective view of the vicinity of the development roller shown in FIG. 3.

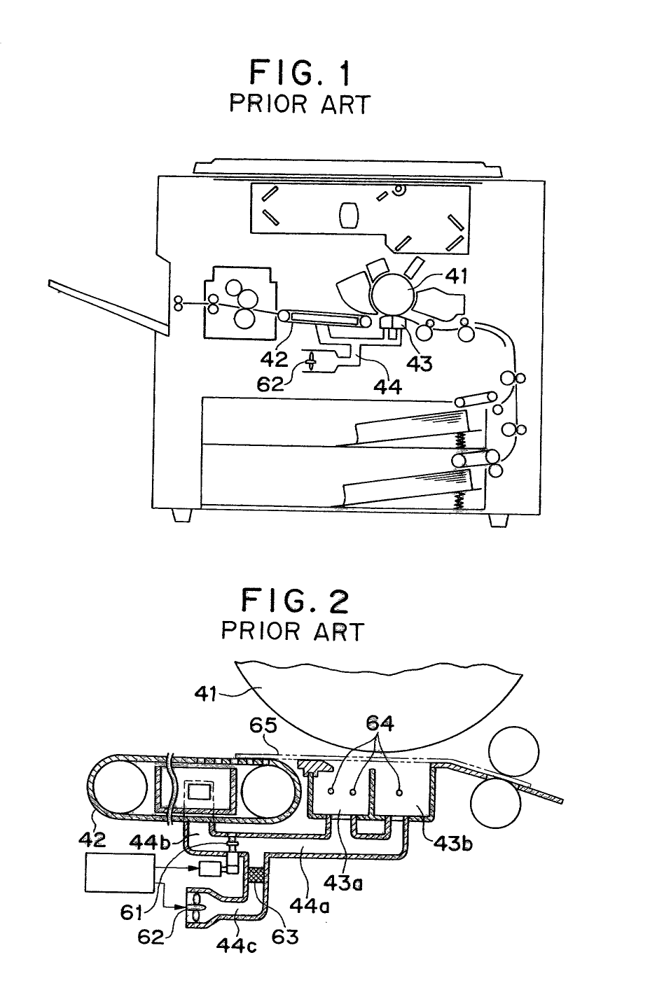

### PREFERRED EMBODIMENTS OF THE INVENTION

Now, the present invention is more specifically described with reference to accompanying drawings.

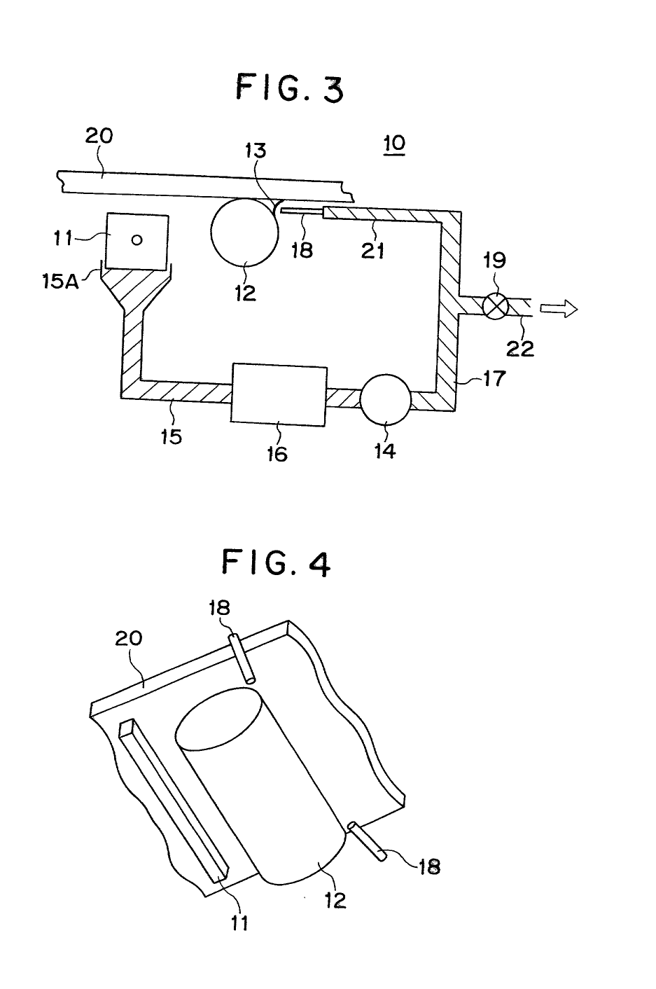

Referring to FIG. 3, an electrophotographic imaging device, implemented as a copying machine, according to an embodiment of the present invention includes a photoreceptor 20, a corona electrifier 11 for electrifying the photoreceptor 20 by generating a corona discharge on the photoreceptor 20, a developing roller 12 for developing an electrostatic latent image on the photoreceptor 20, and a ventilation system.

The ventilation system includes a suction duct 15 having a suction port 15A for introducing air from the vicinity of the corona electrifier 11, an exhaust duct 17 including a first branch duct 21 having a pair of nozzles 18 at the distal end thereof and a second branch duct 22 having a bypass throttle valve 19 between the branch point of the exhaust duct 17 and outside the electrophotographic imaging device, an exhaust fan 14 for moving air from the suction duct 15 toward the exhaust duct 17 for ventilation, an ozone remover 16 disposed at the suction duct 15 between the suction port 15A and the exhaust fan 14 for removing the ozone generated by the corona electrifier 11.

The suction duct 15 and the exhaust duct 17 may be made of rigid tube, flexible tube or a metallic sheet bent to have a rectangular shape in a sectional view. The exhaust fan 14 may be replaced by an air pump capable of exhausting air.

In operation of the electrophotographic imaging device of FIG. 3, the corona electrifier 11 electrifies the photoreceptor 20 to have a photosensitivity in an electrifying step, the photoreceptor 20 is then exposed to a light image to form thereon an electrostatic latent image by discharge using the photosensitivity of the photoreceptor 20 in an exposure step, the latent image on the photoreceptor 20 is developed by using ink or toner in a developing step, the developed image is then transcribed to a plain paper or other recording mediums in a transcribing step, and the transcribed image is then fixed onto the plain paper or other recording mediums in a fixing step. In addition to these five steps, a cleaning step is conducted for cleaning the photoreceptor 20 during repeated cycles of operation. In FIG. 3, the electrostatic imaging device is shown for the portion thereof executing the electrifying step and the developing step.

The corona electrifier 11 generates a corona discharge on the surface of the photoreceptor 20 to thereby electrify the photoreceptor 20 uniformly on the surface thereof. In this step, the corona electrifier 11 generates undesirable ozone. The photoreceptor 20 thus electrified has a photosensitivity, and forms thereon an electrostatic latent image corresponding to the image on an original sheet after exposure by the light passing through the original sheet. Ink 13 includes coloring pigment or toner for developing the electrostatic latent image to form a positive ink image.

Referring to FIG. 4, the developing roller 12 having a surface on which the ink 13 is scattered rotates around its axis. A pair of air nozzles 18 are disposed at both the ends of the developing roller 12 as viewed in the axial direction. The air nozzle 18 blasts air onto the surface of developing roller 12 with a specified flow rate and a specified speed, provided that the suction duct 15 and the first branch duct 21 are maintained above specified pressures. The air nozzle 18 thereby prevents the ink 13 from leaking in the transverse direction. The photoreceptor 20 moves in a horizontal direction along the surface of the developing roller 12, whereby the ink 13 is attached onto the bottom surface of the photoreceptor 20 to form a positive ink image corresponding to the electrostatic latent image on the photoreceptor 12.

The suction duct 15 connects the suction port 15A disposed in the vicinity of the rear surface of the corona electrifier 11 and the exhaust fan 14 whilc passing through the ozone remover 16, whereas the exhaust duct 17 connects the exhaust port of the exhaust fan 14 and the external of the imaging device and the air nozzles 18. The air nozzles 18 are connected at the first branch 21 branching from a portion of the exhaust duct 17the located at the upper stream of the bypass throttle valve 19.

The ozone remover 16 removes the ozone generated by the corona electrifier 11 in the air flowing through the suction duct 15, thereby cleaning the exhaust air and preventing the photoreceptor 20 from being deteriorated by the ozone. The ozone remover 16 may include a filter and/or catalyst for decomposing the removed ozone

It is preferable that the speed of the air be lower and the flow rate of the air be higher at the suction port 15A disposed in the vicinity of the corona electrifier 11, with the air pressure being lower, for effectively removing the ozone. On the other hand, it is preferable that the flow rate of the air be lower and the speed of the air be higher in the vicinity of the air nozzle 18, with the air pressure being higher, for effectively suppressing the ink leakage. This necessitates adjustment of the pressure of the air within the exhaust duct 17 because the flow rate of the air is equal between the suction duct 15 and the exhaust duct 17.

In view of the above, the bypass throttle valve 19 is disposed between the branch point of the exhaust duct 17 and the external of the housing of the imaging device. The opening ratio of the bypass throttle valve 19 is controlled to control the exhaust air to outside the imaging device for adjusting the internal pressure of the exhaust duct 17 at a suitable pressure which does not reduce the ability of the exhaust fan 14.

The bypass throttle valve 19 may be replaced by at least one exhausting orifice or nozzle, which may be disposed at the distal end of the second branch of the exhaust duct 17. The inner diameter and the number of the exhausting orifices are designed to maintain the internal pressure of the exhaust duct 17 without reducing the exhausting ability of the exhaust fan 14. The bypass throttle valve 19 may be disposed in the vicinity of the air nozzles 18. Instead, an additional bypass throttle valve may be provided between the branch point of the exhaust duct 17 and the air nozzles 18. The latter configuration is more advantageous in that the adjustment of the air pressure and the flow rates at the suction duct 15 and the exhaust duct 17 can be performed with ease.

Since the above embodiments are described only for examples, the present invention is not limited to the above embodiments and various modifications or alterations can be easily made therefrom by those skilled in the art without departing from the scope of the present invention.

What is claimed is:

1. An electrostatic imaging device comprising: a photoreceptor for generating thereon an electrostatic image: a corona electrifier for generating corona discharge to electrify said photoreceptor; a developer for developing said electrostatic latent image on said photoreceptor; and a ventilation system including a suction duct having a suction port disposed in a vicinity of said corona electrifier and an exhausting duct having an air nozzle disposed in a vicinity of said developing roller for blasting air to said coronal electrifier, a fan disposed between said suction duct and said exhaust duct for ventilating said suction duct and said exhaust duct, and an ozone remover disposed in operative relationship with said suction duct or said exhaust duct for removing ozone from air in said suction duct or said exhaust duct.

2. The electrostatic imaging device as defined in claim 1, wherein said ventilation system further includes a branch duct branching from a portion of said exhaust duct and having an exhaust port, and a throttle valve disposed in said branch duct between said exhaust port and said portion of said exhaust duct.

3. The electrostatic imaging device as defined in claim 1, wherein said ozone remover includes a filter and/or catalyst.

4. The electrostatic imaging device as defined in claim 1, wherein said air nozzle is associated with a throttle valve.
